(19) United States
(12) Patent Application Publication
(10) Pub. No.: US 2007/0075142 A1
(43) Pub. Date: Apr. 5, 2007

(54) Mobile computer with integrated UHF RFID reader

(75) Inventors: David E. Bellows, Wantagh, NY (US); Richard T. Knadle JR., Dix Hills, NY (US); Thomas Wulff, North Patchogue, NY (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/240,668

(22) Filed: Sep. 30, 2005

(51) Int. Cl. G06K 7/08

(52) U.S. Cl. 235/451

(57) ABSTRACT

A mobile computing device as described herein includes an integrated UHF radio frequency identification (“RFID”) reader and UHF RFID reader antenna within the housing of the device. The mobile computing device supports traditional general purpose functions, such as data capture, scanning, imaging, or the like, in addition to RFID reader functions. The housing of the device fully encloses the RFID reader and antenna such that the RFID components are permanently enclosed by the housing. The integrated design of the device eliminates the need for an RFID accessory and provides for multi-tasking and multi-functioning.

### TECHNICAL FIELD OF THE INVENTION

The present invention relates generally to mobile computing devices. More particularly, the present invention relates to a mobile computer having an integrated radio frequency identification (“RFID”) reader and RFID antenna fully contained within its housing.

### BACKGROUND OF THE INVENTION

RFID systems are well known and the prior art includes different types of RFID systems, different applications for RFID systems, and different data communication protocols for RFID systems. RFID systems are commonly utilized for product tracking, product identification, and inventory control in manufacturing, warehouse, and retail environments. Briefly, an RFID system includes two primary components: a reader (also known as an interrogator); and a tag (also known as a transponder). The tag is a miniature device that is capable of responding, via an air channel, to a radio frequency (“RF”) signal generated by the reader. The tag is configured to generate a reflected RF signal in response to the RF signal emitted from the reader. The reflected RF signal is modulated in a manner that conveys identification data back to the reader. The identification data can then be stored, processed, displayed, or transmitted by the reader as needed.

Due to the size and complexity of the necessary components, fixed RFID readers mounted by doorways, loading docks, and assembly lines were the first to be developed and deployed in the field. As RFID technology matures and continues to emerge as a force in the data acquisition industry, the need for mobile RFID readers becomes increasingly important. To date, the integration of RFID readers into mobile computing devices has not been fully developed to the same extent as other mobile computing features, such as scanning and wireless data communication.

The prior art is replete with mobile computing devices, including general purpose devices and devices that are designed to perform specific functions. Mobile computers intended for industrial, retail, shipping, and inventory applications are typically designed to be rugged, robust, and weatherproof. Such mobile computers are available from manufacturers such as Symbol Technologies, Inc. Currently, RFID readers are primarily an accessory for mobile computing devices. As a peripheral, an RFID reader accessory is a physically distinct component that is attached to the host mobile computing device, which supplies additional functionality as needed. Incorporation of the RFID reading feature is accomplished via external means and, therefore, the RFID reader is not truly integrated within the mobile computer itself.

FIG. 1 is a perspective view of a conventional mobile computer 100 with an RFID reader accessory 102 attached thereto. Mobile computer 100 by itself does not include RFID reader functionality, and RFID reader accessory 102 must be physically and electronically coupled to mobile computer 100 before the combined assembly can be operated as a portable RFID reader. RFID reader accessory 102, which contains the RFID reader transceiver and the RFID antenna, attaches to the end of mobile computer 100 such that the operator can utilize the native display and keypad of mobile computer 100. FIG. 2 is a perspective view of another conventional mobile computer 200 with an RFID reader accessory 202 attached thereto. Again, mobile computer 200 must be physically and electronically connected to RFID reader accessory 202 before the combined assembly can be operated as a portable RFID reader. Both of the systems shown in FIG. 1 and FIG. 2 employ an RFID reader device that is external to the mobile computer housing. Such an arrangement can be heavy, bulky, and cumbersome to use in the field.

In some instances, development efforts have progressed to the point where the addition of RFID functionality is achieved with an accessory that is partially internal to the mobile computer. In this regard, FIG. 3 is a top view of a conventional mobile computer 300 with an RFID reader card 302 inserted therein. Although RFID reader card 302 is partially inserted into the housing of mobile computer 300, it still represents a separate piece of hardware attached to mobile computer 300. RFID reader card 302 includes a separate housing that contains the RFID reader transceiver and the RFID antenna. The exposed and protruding portion of the RFID reader card 302 contains the RFID antenna.

The three systems mentioned above are all examples where the RFID capability is removed from the mobile computing device once the respective RFID reader accessory is detached. In other words, the RFID functionality is not always present in the mobile computer. Other RFID reader devices claim to be “portable” or “mobile” to some extent. A number of these devices, however, only function as RFID readers (i.e., they do not provide traditional mobile computing functionality such as data acquisition and processing, wireless data communication, and the like). Indeed, such devices are still classified as accessories because they must be connected to a hand-held or fixed-mount computing device before use. Another conventional portable RFID reader can stand alone with its own power supply, antenna, and transceiver. Although this type of RFID reader can interrogate RFID tags without being attached to a mobile computing device, the information encoded on the RFID tags cannot be communicated to the end user until the RFID reader is coupled to the host mobile computing device. Consequently, this does not represent a completely integrated solution.

Other designs have affixed a protruding RFID antenna structure to the mobile computing device using bolts, screws, adhesive, or the like. Although this creates an assembly where the RFID antenna is not easily removable, the antenna is not integrated within the enclosure or housing of the mobile computing device itself. Rather, the RFID antenna forms a noticeable protrusion or extension from the mobile computing device housing. This protrusion can be aesthetically unpleasing and it may cause the mobile computer to become unbalanced (which can be important for hand held applications).

Accordingly, it is desirable to have a hand held mobile computer with an integrated RFID reader, where the housing of the mobile computer remains compact and free of noticeable protrusions for accommodating the RFID antenna structure. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

A mobile computer configured in accordance with an example embodiment of the invention supports general purpose operations along with RFID operations. The mobile computer incorporates an internally integrated RFID antenna and RFID reader components in a manner that does not noticeably increase the size of the mobile computer housing. In the example embodiment, the RFID antenna is completely contained within the housing of the mobile computer.

The above and other aspects of the invention may be carried out in one form by a mobile computer comprising a housing, a permanent RFID antenna located within a non-protruding section of the housing, an RFID reader sub-module coupled to the RFID antenna and located within the housing, the RFID reader sub-module being configured to support RFID functions of the mobile computer, and a data capture sub-module located within the housing, the data capture sub-module being configured to support data capture functions of the mobile computer.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a perspective view of a conventional mobile computer with an RFID reader accessory attached thereto;

FIG. 2 is a perspective view of another conventional mobile computer with an RFID reader accessory attached thereto;

FIG. 3 is a top view of a conventional mobile computer with an RFID reader card inserted therein;

FIG. 4 is an exploded perspective view of a mobile computer configured in accordance with an example embodiment of the invention;

FIG. 5 is a perspective view of the mobile computer shown in FIG. 4, as assembled; and

FIG. 6 is a schematic representation of a mobile computer configured in accordance with an example embodiment of the invention.

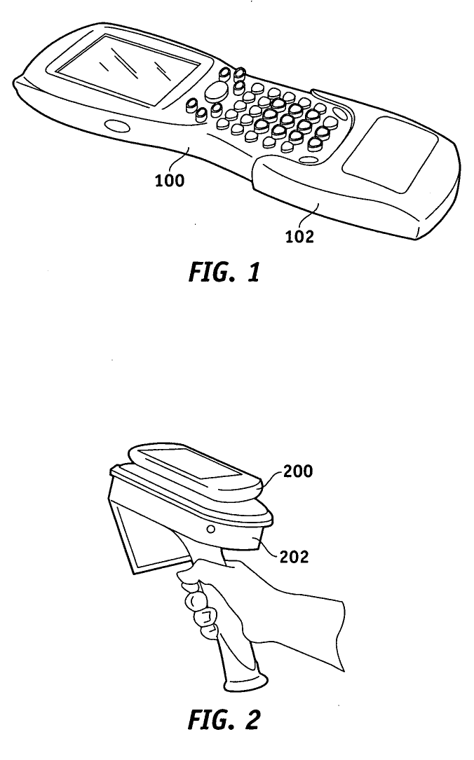

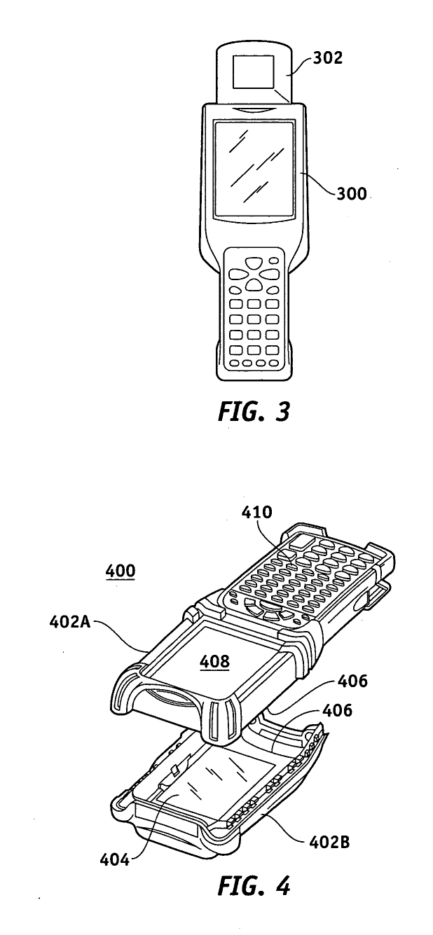

### DETAILED DESCRIPTION OF THE INVENTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to RFID data transmission, RFID system architectures, mobile computer architectures, mobile data capture techniques, RF antenna design, signal processing, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. Thus, although the schematic shown in FIG. 6 depicts one example arrangement of elements, additional intervening elements, devices, features, or components may be present in an actual embodiment (assuming that the functionality of the device is not adversely affected).

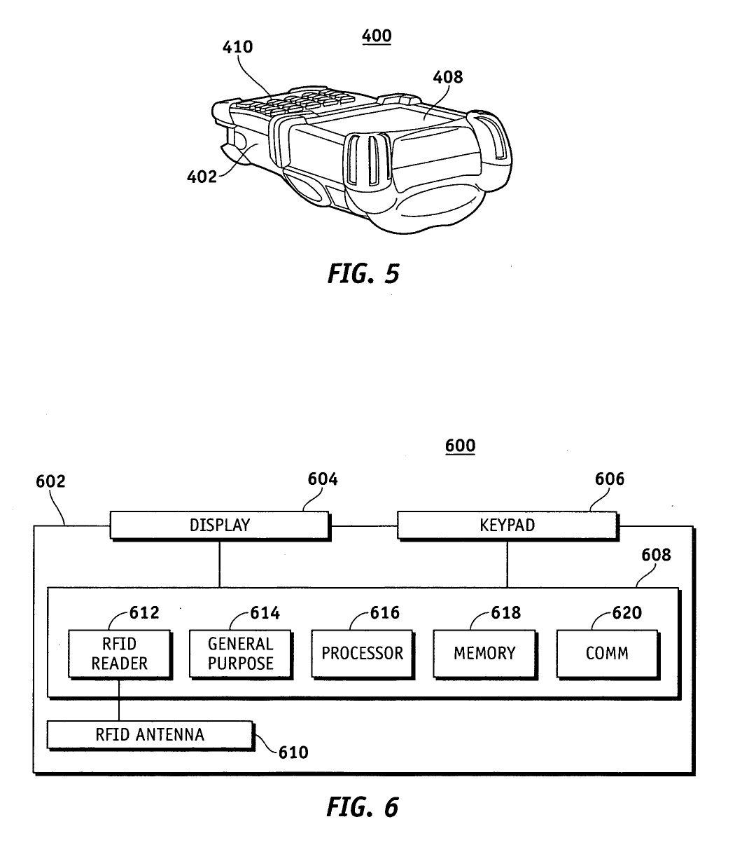

FIG. 4 is an exploded perspective view of a mobile computer 400 configured in accordance with an example embodiment of the invention, and FIG. 5 is a perspective view of mobile computer 400, as assembled. As used herein, a “mobile computer” refers to a portable, hand held computing device that includes at least a processor, memory, and a user interface. A mobile computer typically includes a combination of any of the following features, without limitation: a display element; a keypad or keyboard; a touchpad; a stylus writing pad; a data capture module (e.g., a bar code scanner, an imager, a magnetic stripe reader); a WAN transceiver/antenna; a LAN transceiver/antenna; a PAN transceiver/antenna; a battery or other power supply; a GPS receiver; a data communication module; input/output connectors; and a trigger. Conventional mobile computers are available from Symbol Technologies, Inc and other manufacturers. For example, the following product model numbers refer to mobile computers that are currently available from Symbol Technologies, Inc.: MC9000, MC3000, PDT8100, PPT8800, and MC50. As used herein, a “mobile computer” may also refer to a personal digital assistant (“PDA”), a palmtop computer, a notebook computer, a laptop computer, a suitably equipped wireless telephone, or the like.

Mobile computer 400, which represents one practical embodiment of the invention, includes a housing 402 that is suitably shaped, sized, and configured to contain the electronics, functional modules and sub-modules, and operating components of mobile computer 400. FIG. 4 depicts a first portion of housing 402a and a second portion of housing 402b, which are coupled and sealed together to form housing 402 (see FIG. 5). Although not shown in FIG. 4, mobile computer 400 includes an RFID reader sub-module that is configured to support RFID functions of mobile computer 400, in addition to a general purpose sub-module that is configured to support non-RFID functions of mobile computer 400. The RFID sub-module includes or communicates with an RFID antenna 404, which is contained within housing 402. In practice, RFID antenna 404 is fully contained within an interior space 406 of housing 402.

FIG. 4 schematically depicts RFID antenna 404 as a rectangular sheet, which is coupled to housing 402, to the electronics module, and/or to other components located within housing 402. RFID antenna 404 can be mounted directly to housing 402, to a frame or frames within housing 402, or to the electronic components in housing 402. Mounting can be achieved using any suitable technique, such as adhesive, foam tape, mechanical fasteners, clamps, bezels, snaps, or the like. In this regard, RFID antenna 404 becomes a permanent fixture of mobile computer 400.

Of course, the actual size, shape, topology, and configuration of RFID antenna 404 can be selected to suit the needs of the particular application. In addition, the type of RF antenna utilized for RFID antenna 404 can be selected to suit the needs of the specific mobile computer platform. In accordance with one example embodiment, RFID antenna 404 operates in the 902-928 MHz UHF range for RFID applications, because UHF operation is desirable for long range applications. Alternatively, RFID antenna 404 can operate in another sector of the full 300 MHz to 3.0 GHz UHF band. Briefly, RFID antenna 404 may include one or more conductive radiating elements that interact with one or more conductive ground elements, such as a ground plane. The radiating elements may be coupled to (or formed with) an RF connector for coupling to an RFID reader transceiver located within housing 402.

RFID antenna 404 may utilize a single radiating element, two radiating elements that form a spatial diversity antenna architecture, or any number of radiating elements as needed. In practice, RFID antenna 404 may utilize a solid conductor (e.g., a copper wire), a thin conductive material (e.g., a copper sheet), a metallic trace etched onto a dielectric mounting element, a flexible conductor formed on a flexible adhesive tape, or the like. In yet other embodiments of the invention, RFID antenna 404 may leverage any suitable RF antenna technology, including, without limitation: microstrip; stripline; coaxial; twin lead; coplanar waveguide; traveling wave; and the like.

In a practical embodiment of the invention, RFID antenna 404 is tuned in response to RF characteristics of the electronics module contained within housing 402. Such tuning may be necessary due to the compact packaging of mobile computer 400, due to the close proximity of RFID antenna 404 relative to other conductive and active structures and components located within housing 402, and because RFID antenna 404 is preferably located in a non-protruding section of housing 402. For example, the general purpose sub-module of mobile computer 400 may include a wireless data communication element, and RFID antenna 404 can be suitably tuned to avoid RF interference with the wireless data communication element.

Moreover, RFID antenna 404 may be tuned in accordance with conductive structure located in mobile computer 400. Such tuning may involve, for example, and without limitation: tuning or adjusting the shape or size of the radiating element(s); providing RF matching elements; positioning and adjusting the orientation of RFID antenna 404 within housing 402; tuning or adjusting the shape, size, or topology of RFID antenna 404; tuning or adjusting the mounting distance of RFID antenna 404 relative to the electronics module located within housing 402; selecting the materials utilized for RFID antenna 404; selecting suitable RF connectors and cables; and/or selecting the manner in which RFID antenna 404 is manufactured.

Referring to FIG. 5, after housing 402 is assembled, RFID antenna 404 becomes fully enclosed by housing 402 such that RFID antenna 404 is not externally visible or detectable. In this regard, housing 402 itself is configured such that RFID antenna 404 resides within a non-protruding section of housing 402. In other words, housing 402 need not include a protruding pocket, section, or feature that is specifically designed to accommodate RFID antenna 404. This design makes mobile computer 400 less bulky and easier to handle, while facilitating even weight distribution. In practice, RFID antenna 404 can be mounted anywhere inside housing 402. To anticipate typical operator handling of mobile computer 400, RFID antenna 404 may be located near the “top” of housing 402 (toward display element 408 rather than keypad 410). This mounting location can enhance the range of the RFID reader, assuming that the operator will point the top of mobile computer 400 toward the item under interrogation.

Mobile computer 400 also includes a number of features, functions, and components that can be utilized to support any number of general purpose functions. For example, mobile computer 400 preferably includes a display element 408, a keypad 410, and at least one connection port (not shown), which may be utilized for accessories, data communication, or the like. Mobile computer 400 may include general purpose functionality and associated hardware configured to support data capture functions including one or more of: bar code reading; imaging; magnetic stripe reading; GPS data receiving; and WAN, LAN, PAN, or other RF communications. In addition to such general purpose functions, mobile computer 400 is also configured to support RFID reader functions.

FIG. 6 is a schematic representation of a mobile computer 600 configured in accordance with an example embodiment of the invention. FIG. 6 depicts mobile computer 600 in an over simplified manner, and a practical embodiment will of course include many additional features and components. Mobile computer 600 generally includes a housing 602, a display element 604 that is visible from the outside of housing 602, a keypad 606 that is accessible from the outside of housing 602, an electronics module 608 contained within housing 602, and an RFID antenna 610 contained within housing 602. Mobile computer 600 may also include a touch panel or other input/output elements.

Display 604 and keypad 606 function as input/output elements for the operator of mobile computer 600. Display 604 and keypad 606 may be coupled to electronics module 608 as necessary to support input/output functions in a conventional manner. Electronics module 608 represents the hardware components, logical components, and software functionality of mobile computer 600. In practical embodiments, electronics module 608 may be physically realized as an integrated component, board, card, or package mounted within housing 602. As depicted in FIG. 6, electronics module 608 is coupled to RFID antenna 610 using suitable techniques. For example, electronics module 608 and RFID antenna 610 may be connected via an RF cable and RF connector assemblies. To satisfy the compact packaging requirements that may be associated with a practical implementation, RFID antenna 610 may be located proximate and adjacent to electronics module 608, as depicted in FIG. 6.

Electronics module 608 may generally include a number of sub-modules, features, and components configured to support the functions described herein. For example, electronics module 608 may include an RFID reader sub-module 612, a general purpose sub-module 614, at least one processor 616, memory 618, and a data communication sub-module 620. The distinct functional blocks of FIG. 6 are useful for purposes of description. In a practical embodiment, the various sub-modules and functions need not be distinct physical or distinct functional elements. In other words, these (and other) functional modules of mobile computer 600 may be realized as combined processing logic, a single application program, or the like.

RFID reader sub-module 612 is suitably configured to support RFID functions of mobile computer 600. In this regard, RFID reader sub-module 612 may include an RFID reader transceiver that generates RFID interrogation signals and receives reflected RFID signals generated by RFID tags in response to the interrogation signals. In the example embodiment described herein, RFID reader sub-module 612 is designed to operate in the UHF frequency band designated for RFID systems. Alternate embodiments may instead utilize the High Frequency band or the Low Frequency band designated for RFID systems. The operation of RFID readers and RFID transceivers are generally known and, therefore, will not be described in detail herein. Notably, in this example embodiment, RFID reader sub-module 612, RFID antenna 610, and all RFID components of mobile computer 600 are enclosed within housing 602 and these internal RFID components are inaccessible unless housing 602 is broken or disassembled.

General purpose sub-module 614 is responsible for handling non-RFID functions of mobile computer 600. For example, general purpose sub-module 614 may include a wireless data communication element that supports bi-directional wireless data transfer using suitable wireless data transmission protocols and methodologies. In such a deployment, RFID antenna 610 may be tuned to avoid RF interference with the wireless data communication elements. Alternatively (or additionally), general purpose sub-module 614 may be configured to support data communication over physical connections. As another example, general purpose sub-module 614 may be configured to support data capture functions of mobile computer 600, where such data capture functions include one or more of: bar code reading; imaging; magnetic stripe reading; GPS data receiving; and IrDA. These data capture modes can be utilized to support traditional uses of mobile computer 600, e.g., inventory control, tracking of packages, retail checkout, rental car returns, and other applications. Although not separately depicted in FIG. 6, mobile computer 600 may include a data capture sub-module that is configured to support such data capture modes. Of course, RFID antenna 610 may also be tuned to avoid RF interference with the data capture sub-module.

Processor 616 may be any general purpose microprocessor, controller, or microcontroller that is suitably configured to control the operation of mobile computer 600. In practice, processor 616 may execute one or more software applications that provide the desired functionality for mobile computer 600. Memory 618 may be realized as any processor-readable medium, including an electronic circuit, a semiconductor memory device, a ROM, a flash memory, an erasable ROM, a floppy diskette, a CD-ROM, an optical disk, a hard disk, an organic memory element, or the like. As an example, memory 618 is capable of storing RFID data captured by RFID reader 612 while mobile computer 600 is operating in the RFID reader mode.

Data communication sub-module 620 is configured to support data communication functions of mobile computer 600. Although depicted as a distinct sub-module, data communication sub-module 620 may be realized as a portion of general purpose sub-module 614. Data communication sub-module 620 may be configured to communicate with another computing device, a network server, a peripheral device, or the like. In connection with the RFID operating mode, data communication sub-module 620 may transmit the collected RFID data to a remote computing device in accordance with at least one data communication protocol. In a practical embodiment, mobile computer 600 may utilize one or more standardized data communication protocols (either wireless or wired). Such standardized data communication protocols include, without limitation: Bluetooth; IEEE 802.11 (any variation thereof); Ethernet; IEEE 1394 (Firewire); GPRS; USB; IEEE 802.15.4 (ZigBee); IEEE 802.16 (WMAN); or IrDA (infrared). Moreover, data communication sub-module 620 may be realized with hardware, software, and/or firmware using known techniques and technologies. For example, mobile computer 600 may include a wireless port configured to support wireless data communication and/or a cable or wire port configured to support data communication via a tangible link.

A mobile computing device according to the invention is capable of functioning in one or more conventional modes and/or an RFID reader mode. The primary functions of the mobile computing device need not be limited to data capture and RFID tag interrogation. Rather, the mobile computing device is capable of multi-tasking and multi-functioning.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A mobile computer comprising:
a housing;
a permanent radio frequency identification (“RFID”) antenna, fully contained within said housing;
an electronics module contained within said housing and coupled to said permanent RFID antenna, said electronics module comprising:
an RFID reader sub-module configured to support RFID functions of the mobile computer; and
a general purpose sub-module configured to support non-RFID functions of the mobile computer.

2. A mobile computer according to claim 1, said permanent RFID antenna being located adjacent to said electronics module.

3. A mobile computer according to claim 1, said permanent RFID antenna being located in a non-protruding section of said housing.

4. A mobile computer according to claim 1, said permanent RFID antenna being tuned in response to radio frequency characteristics of said electronics module.

5. A mobile computer according to claim 4, wherein:
said general purpose sub-module comprises a wireless data communication element; and
said permanent RFID antenna is tuned to avoid radio frequency interference with said wireless data communication element.

6. A mobile computer according to claim 1, said RFID reader sub-module comprising an RFID reader transceiver.

7. A mobile computer according to claim 1, said general purpose sub-module being configured to support data capture functions of the mobile computer.

8. A mobile computer according to claim 7, said general purpose sub-module being configured to support data capture functions including one or more of: bar code reading; imaging; magnetic stripe reading; global positioning system data receiving; IrDA communication; WAN communication; LAN communication; and PAN communication.

9. A mobile computer according to claim 1, said general purpose sub-module being configured to support data communication functions of the mobile computer.

10. A mobile computer comprising:
a housing;
a permanent radio frequency identification (“RFID”) antenna located within a non-protruding section of said housing;
an RFID reader sub-module coupled to said RFID antenna and located within said housing, said RFID reader sub-module being configured to support RFID functions of the mobile computer; and
a data capture sub-module located within said housing, said data capture sub-module being configured to support data capture functions of the mobile computer.

11. A mobile computer according to claim 10, said permanent RFID antenna being fully enclosed by said housing.

12. A mobile computer according to claim 10, further comprising a data communication sub-module configured to support data communication functions of the mobile computer.

13. A mobile computer according to claim 12, wherein:
said data communication sub-module comprises a wireless data communication element; and
said permanent RFID antenna is tuned to avoid radio frequency interference with said wireless data communication element.

14. A mobile computer according to claim 10, said data capture sub-module being configured to support data capture functions including one or more of: bar code reading; imaging; magnetic stripe reading; global positioning system data receiving; IrDA communication; WAN communication; LAN communication; and PAN communication.

15. A mobile computer comprising:
a housing;
a non-protruding internal radio frequency identification (“RFID”) antenna permanently located within said housing;
an RFID reader sub-module coupled to said RFID antenna and located within said housing, said RFID reader sub-module being configured to support RFID functions of the mobile computer; and
a data capture sub-module located within said housing, said data capture sub-module being configured to support data capture functions of the mobile computer.

16. A mobile computer according to claim 15, wherein said housing is configured such that said RFID antenna is not externally detectable.

17. A mobile computer according to claim 15, wherein all RFID components of the mobile computer are enclosed within said housing.

18. A mobile computer according to claim 15, said RFID antenna being tuned to avoid radio frequency interference with said data capture sub-module.

19. A mobile computer according to claim 15, said data capture sub-module being configured to support data capture functions including one or more of: bar code reading; imaging; magnetic stripe reading; global positioning system data receiving; IrDA communication; WAN communication; LAN communication; and PAN communication.
